(19) United States
(12) Patent Application Publication
(10) Pub. No.: US 2007/0259445 A1
(43) Pub. Date: Nov. 8, 2007

(54) QUANTITATIVE ANALYSIS OF SURFACE-DERIVED SAMPLES USING MASS SPECTROMETRY

(76) Inventor: Blas Cerda, Milford, MA (US)

Correspondence Address: CESARI AND MCKENNA, LLP, 88 BLACK FALCON AVENUE, BOSTON, MA, 02210, US

(21) Appl. No.: 11/744,513

(22) Filed: May 4, 2007

Related U.S. Application Data
(60) Provisional application No. 60/797,993, filed on May 5, 2006.

(51) Int. Cl. G01N 24/00

(52) U.S. Cl. 436/173

(57) ABSTRACT

A substrate incorporating an internal standard facilitates quantitating analytes in a sample by surface-interrogating mass spectrometry techniques without wet chemistry sample preparation. The user disposes a sample to be analyzed onto the surface of the pretreated substrate. Then the sample-bearing solid substrate, which incorporates an internal standard for each analyte to be quantitated, is ready for interrogation.

### CROSS-REFERENCE TO RELATED APPLICATION

The present application claims the benefit of U.S. Provisional Patent Application Ser. No. 60/797,993, which was filed on May 5, 2006, by Blas Cerda for Quantitative Analysis of Surface-Derived Samples using Mass Spectrometry and is hereby incorporated by reference.

### BACKGROUND OF THE INVENTION

1. Field of the Invention

This invention relates to surface-interrogating mass spectrometric techniques. In particular, this invention relates to using these techniques for one-step quantitative analysis of samples disposed on surfaces.

2. Background Information

Each year, at least 4 million babies—more than 98% of all newborn children—in the United States are tested for congenital disorders which, undiagnosed, may cause mental retardation, severe illness, and premature death in infants. Specific metabolic disorders (e.g., phenylketonuria [PKU]), hematologic disorders (e.g., sickle cell disease), and endocrinopathies (e.g., hypothyroidism) can each be diagnosed by determining whether blood levels of an analyte such as an amino acid, hemoglobin variant, or hormone, respectively, corresponding to the specific disorder are within expected normal levels.

Typically a blood sample taken from a baby's heel at the hospital, within 48 hours of birth, is deposed on a filter paper card. Fixed in this way on the card, the “blood spot” is stable and easily managed until sample preparation and analysis are performed. In general, these steps are not handled at the hospitals where the samples are collected, but rather the samples are sent to a state public health facility or other participating laboratory and processed on a larger scale.

Mass spectrometry is well suited to this analysis because it is able to certify the quantity of several distinct analytes simultaneously and consequently can screen for many disorders in one assay. Nonetheless, each assay includes several preparation steps, each presenting opportunities for introducing error due to sample contamination or analyte loss. Namely, in order to detect analytes of interest by this method, a portion of the filter paper card bearing the sample is punched out and placed in a sample well to extract the blood with solvent. In some cases, the analyte is also derivitized. In order to quantitate the detected analytes, sample preparation must furthermore include adding to the eluted sample a known amount of an internal standard for each analyte.

Recent developments in mass spectrometry have facilitated detection of analytes directly from samples on surfaces, eliminating the need for sample preparation procedures that put the sample in solution. The first ambient mass spectrometry technique, DESI (desorption electrospray ionization) uses a liquid spray, such as of methanol or aqueous methanol, sprayed onto a surface constituting the specimen of interest so as to produce ions from the specimen. These ions are drawn into the mass spectrometer for analysis. (See, for example, Takáts et al., “Mass Spectrometry Sampling Under Ambient Conditions with Desorption Electrospray Ionization” Science; 2004; 36, 471-3; and U.S. Patent Application Publication No. 2005/0230635).

In the commercial technique known as DART (Direct Analysis in Real Time), excited-state species (metastable helium or nitrogen molecules) react with molecules in the sample and with atmospheric molecules such as water to form ions which are drawn into the mass spectrometer. (See, for example, Cody et al., “Versatile New Ion Source for the Analysis of Materials in Open Air under Ambient Conditions”, Anal. Chem.; 2005; 77(8), 2297-2302 and U.S. Patent Application Publication No. 2005/0196871.)

DESI and DART have been used for qualitative interrogation of a wide range of surfaces directly, thereby obtaining high quality mass spectra for a wide range of molecules. Compounds including explosives, chemical warfare simulants, amino acids, peptides, proteins, drug molecules, alkaloids, terpenoids and steroids have been successfully ionized by these methods. It has been noted that biological fluids can be directly analyzed by DESI in the form of dried spots on paper or other appropriate surface. (See, for example, Takáts et al., “Ambient mass spectrometry using desorption electrospray ionization (DESI): instrumentation, mechanisms and applications in forensics, chemistry, and biology,” J. Mass Spectrom.; 2005; 40: 1261-1275). A DESI spectrum containing hundreds of peaks identifying sample components of dried fluids such as blood, urine or plasma can be assembled in less than a minute.

Furthermore, quantitative determination of diagnostically relevant blood components—for example, acylcarnitines, bile acids, glucose, creatinine and bilirubin—by DESI has been proposed. Such quantitation would be made possible by adding isotope-labeled internal standards to a blood sample prior to deposition on the substrate. Adopting a DESI-type technique to blood screening would reduce the number of preparatory steps compared to current practice. However, by contrast to current quantitative blood screening practice, this requirement would move the residual sample preparatory wet chemistry from the specialized analytical facility to the hospital. Shifting more of the burden of the screening program to the hospitals spreads the complexity of the procedure among a greater number of facilities and practitioners, introducing more variability into sample preparation and, hence, a greater risk of error into the result of the analysis.

### SUMMARY OF THE INVENTION

The invention provides a method for quantitating one or more analytes in a sample by surface-interrogating mass spectrometry techniques. The method is enabled by a novel sample-bearing solid substrate constitution incorporating an internal standard. The substrate of the invention comprises a supporting material and a known amount of an internal standard, incorporated before deposition of the sample on the surface, for each analyte to be quantitated.

In accordance with the method of the invention, a sample to be analyzed is deposited on the prepared substrate. Then the substrate is subjected to a surface-interrogating mass spectrometric technique, which entails transferring energy to the surface of the substrate so as to ionize, for each designated analyte, a component in the sample and the corresponding internal standard and then sorting the ions in a mass spectrometer to determine the relative signal strengths. Using the resulting data, the presence and quantity of analytes is assessed. The sorting capability of mass spectrometry makes it possible to quantitate several analytes in a single run. In principle, this capability is generalizable to one-step analysis of a sample containing any number of analytes.

For example, to assess diagnostically relevant levels of amino acids and carnitines in infant blood, the invention provides a prepared substrate incorporating internal standards in the form of isotopically labeled analogs of the amino acids and carnitines. The blood sample could be deposited on the substrate immediately after collecting it from the newborn or soon thereafter in a hospital laboratory. The substrate bearing the sample is then ready to be taken off site for analysis, without any further preparation. During an analysis the analytes and the internal standards are ionized together, and the resultant mass spectrum indicates the levels of the analytes and of the corresponding internal standards. From these data the concentration of each analyte in the blood sample can be calculated. For disorders having the most straightforward diagnoses, the blood sample would be judged as being within or outside of the expected normal range for a single indicative analyte. For disorders having more complex diagnoses, the levels of several analytes may be relevant.

The invention is not limited to mass spectrometry analysis of blood or even to biological liquids as a class. Rather, the method of the invention is adaptable to quantitation of any analyte having a corresponding internal standard susceptible of joining to a supporting material to form the substrate of the invention and then susceptible of ionizing during the surface-interrogating process.

Neither is the method of the invention limited to any particular technique for ionizing the component of interest on the substrate. Any technique capable of ionizing analytes present on a surface can be used to generate the charged species for input into the mass spectrometer. For example, rather than directing particles to the substrate as in the surface-interrogating approaches already mentioned, radiation could be used to desorb the analyte and internal standard. Matrix-assisted laser desorption/ionization (MALDI) is one such method adaptable to the present invention. (See, for example, U.S. Patent Application Publication No. 2007/0065949.)

The solid substrate of the invention may include supporting materials such as the filter cards used in blood screening (for example, commercially available paper materials such as FTA® and Schleicher, Schueil 903 and CEP papers as well as other commercial “blood card” materials), glass, textiles, ceramics, resin, metals and metalloids—any material suitable for receiving a sample and capable of stably retaining the selected internal standard until analysis.

Further, the substrate of the invention can have any of a variety of physical formats. In addition to the familiar paper card used for storing blood spots, examples include a membrane; swab; a surface configured as a tube, column, slide or vessel; a hollow or solid bead; a fine particulate; a gel; and a matrix. As used herein, “solid substrate” denotes a substrate in the solid phase or a semisolid—as opposed, for example, to a liquid solution—without regard to the porosity of the substrate or any cavities enclosed thereby.

The term “incorporating,” as used herein with reference to the substrate and an internal standard, denotes that the internal standard is a stable integral part of the substrate under normal conditions of storage and handling until exposure to the means of interrogation. Equivalently, the substrate may be described as an internal standard joined or affixed to a supporting material. The prepared substrate may incorporate an internal standard in any physical manner that allows formation of suitable internal standard ions from the internal standard during interrogation.

Similarly, the sample on the sample-bearing substrate may occupy a distinct volume residing on the surface or be partially or completely absorbed so that it penetrates the supporting material. Accordingly, the phrase “disposing the sample on the surface” refers to the manner in which the sample is transferred to the prepared substrate and does not preclude a substrate which absorbs the sample from the surface.

Through incorporation of the internal standard to constitute a prepared substrate, the invention obviates the need to introduce the internal standard into the sample proper before deposition. Thus, the simplified sample preparation afforded by surface-interrogating mass spectrometry techniques is no longer limited to analyte detection. The invention extends this benefit to quantitative analysis. In this way, the invention enables quick and accurate mass spectrometric analysis. In the case of health screening, this benefit translates to reduced risk of false positive or negative diagnosis.

### BRIEF DESCRIPTION OF THE DRAWINGS

The invention description below refers to the accompanying drawings, of which:

FIGS. 1A-1D depict a substrate of the invention having a surface coating of an internal standard, FIG. 1A being a top plan view, FIG. 1B an elevation of the prepared substrate of the invention, and FIGS. 1C and 1D being corresponding views of the prepared substrate bearing a sample for analysis;

FIGS. 2A-2B depict a substrate of the invention having an internal standard diffused into a top layer of the supporting material, FIG. 2A being a top plan view of the substrate bearing a sample, and FIG. 2B an elevation;

FIGS. 3A-3B depict a substrate of the invention having an internal standard impregnating the supporting material at one end of the substrate, FIG. 3A being a top plan view of the substrate bearing a sample, and FIG. 3B a corresponding elevation;

FIGS. 4A-4B depict a substrate of the invention having an internal standard impregnating the entire supporting material, FIG. 4A being a top plan view of the substrate bearing a sample, and FIG. 4B a corresponding elevation; and

FIG. 5 schematically depicts a surface-interrogating mass spectrometry system compatible with the invention.

Features in the drawings are not, in general, drawn to scale.

### DETAILED DESCRIPTION OF AN ILLUSTRATIVE EMBODIMENT

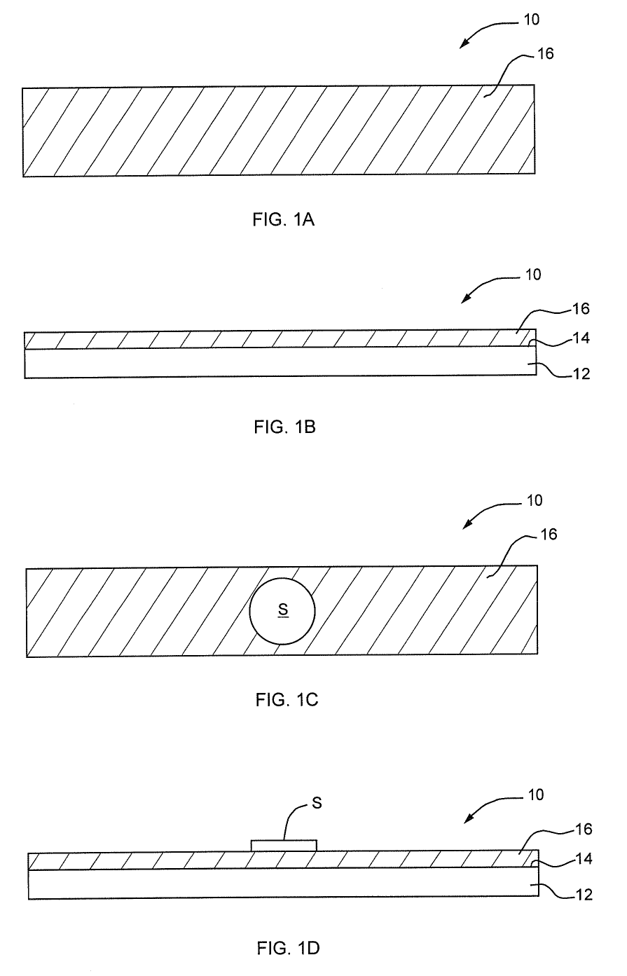

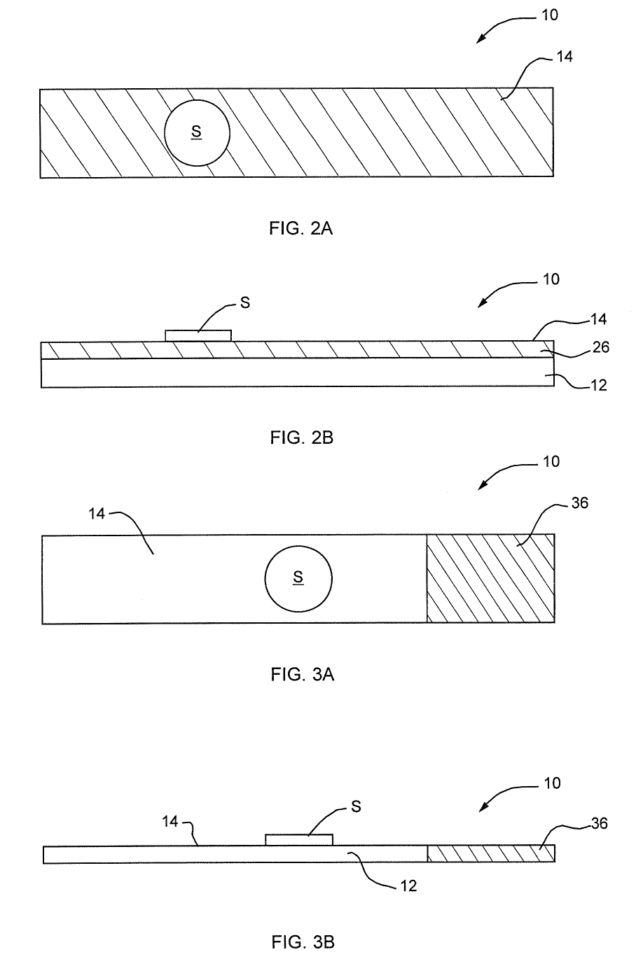

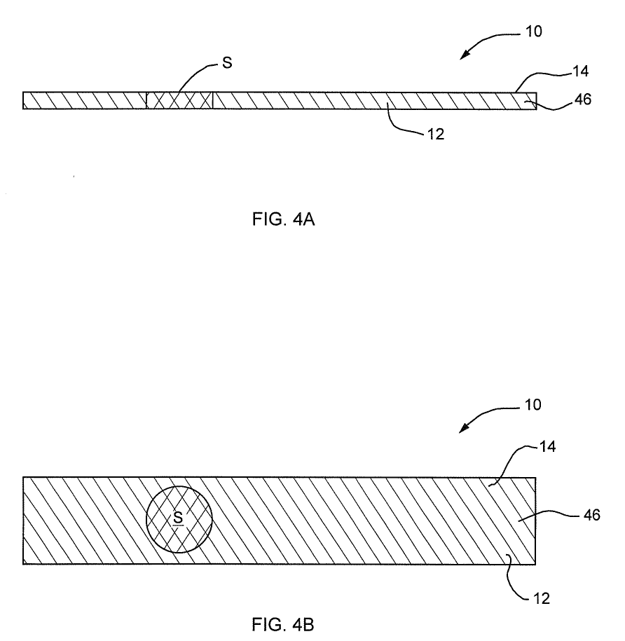

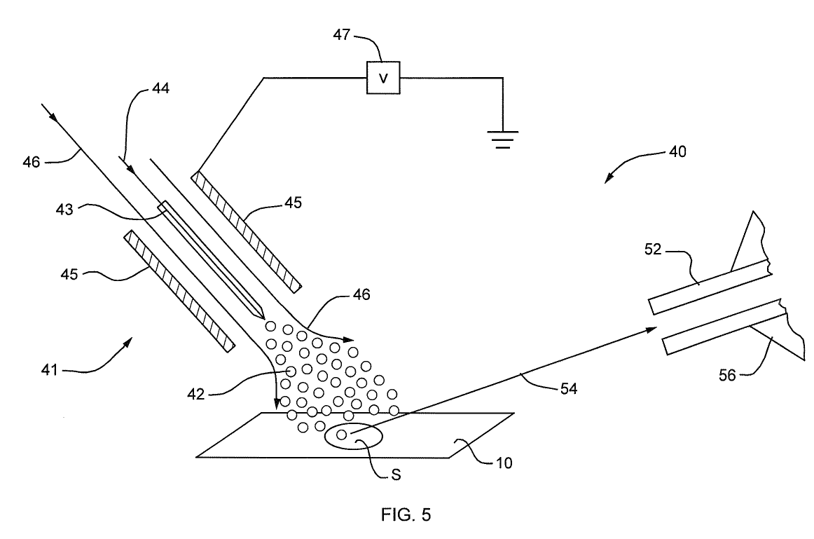

The prepared solid substrate of the invention comprises an internal standard joined to a supporting material. FIG. 1 shows the particular features of an illustrative embodiment of a solid substrate 10. A slab 12 of supporting material having a top face 14 is covered by a substantially distinct layer 16 containing the internal standard. For use in mass spectrometry analysis, a sample is deposited on the substrate 10 so that the sample S is disposed atop the layer 16. With reference to FIG. 2, in another embodiment, the internal standard is contained in an infusion layer 26 penetrating the slab 12 of supporting material. For analysis, the sample S is disposed atop the face 14 of the supporting material, on the infusion layer 26. With reference to FIG. 3, in another embodiment the internal standard permeates the entire depth of the slab 12 of supporting material at one end to form an infusion zone 36. For analysis, the sample S is disposed atop the face 14 of the slab 12 of supporting material. With reference to FIG. 4, in yet another embodiment the internal standard permeates the entire depth of the slab 12, so that the entire supporting material is an infused volume 46. For analysis, the sample S is deposited on the face 14 of the slab 12, from which it is absorbed into the slab 12.

The supporting slab 12 of substrate 10 includes paper, glass, textiles, ceramics, metals, or plastics such as polystyrene, polyethylene glycol, divinylbenzene; methacrylate, polymethacrylate, polyacryloylmorpholide, polyamide, poly(tetrafluoroethylene), polyethylene, polypropylene, poly(4-methylbutene), poly(ethylene terephthalate), nylon, poly(vinyl butyrate), polyvinylidene difluoride (PVDF), silicones, polyformaldehyde. Silicate agarose, cellulose acetate, nitrocellulose, cotton, rayon, and natural plastics are also candidate materials for the supporting material.

The invention does not limit the manner in which the internal standard is joined to the supporting material in the substrate 10. The internal standard can be dried on all or part of a face of the supporting material, infused or diffused into a portion of or throughout the supporting material, chemically linked to the supporting material, or otherwise bound covalently, noncovalently, via hydrogen bonding, capillary forces or surface tension to the supporting material. Joining to the supporting material can be effected by methods such as spraying the internal standard onto a face of the supporting material; soaking a supporting material in a solution containing the internal standard; or by forming the substrate from a slurry containing the internal standard along with the precursor from which the supporting material is formed. Methods for impregnating paper with chemical materials, for example, are well known to those skilled in the art, as described, in U.S. Pat. No. 6,890,481.

FIG. 4 schematically illustrates the substrate 10 of FIGS. 1-3 as it is used with a surface-interrogating mass spectrometry system. A DESI system 40 suitable for use in the present invention uses a conventional electrospray device 41 to generate a spray 42. Any device capable of generating a stream of liquid droplets carried by a nebulizing gas jet may be used to form the DESI spray 42.

The device 40 includes a spray capillary 43 through which a liquid solvent 44 is fed. A nebulizer capillary 45 surrounds the spray capillary 43 to form an annular space through which a nebulizing gas 46 is fed at high velocity. Nitrogen is a typical candidate for the nebulizing gas 46. Aqueous methanol has been used for the liquid solvent 44.

A power supply 47 applies a high voltage to the liquid solvent 44. The interaction between the fast-flowing nebulizing gas 46 and the liquid 44 leaving the capillary 43 forms the desorptive, ionizing spray 42 comprising liquid droplets. The spray 42 also may include neutral atmospheric molecules, nebulizing gas, and gaseous ions.

The spray 42 is directed onto the sample material S which is supported on a prepared substrate 10 incorporating an internal standard. The substrate 10 may be on a platform moveable by well known drive means to desorb and ionize different areas of sample S over time, for example to effect a raster of the entire substrate surface. Electric potential and temperature of such a platform may also be controlled by known means.

An ion transfer line 52 collects the desorbed ions 54 leaving the substrate 10 and introduces them into the atmospheric inlet or interface 56 of a mass spectrometer for analysis. Any atmospheric interface that is normally found in mass spectrometers is suitable for use in a DESI-type system. Interfaces that have been found to work well include a typical heated capillary atmospheric interface and an atmospheric interface that samples via an extended flexible ion transfer line made either of metal or an insulator.

Considerations informing the selection of an internal standard incorporated in substrate 10 for assessment of a particular analyte by a particular experimental configuration are well known to those skilled in the art. In general a suitable internal standard is chemically similar to the analyte, which is what is meant by an internal standard “corresponding” to the analyte. Further, the internal standard must be resolvable from the analyte using mass spectrometry. Finally, the internal standard does not react chemically with the analyte and contains substantially no trace amount of the analyte.

A stable isotopically labeled form of the analyte is commonly found to fulfill these requirements. Extensive published references provide guidance for selecting an internal standard to those skilled in the art. (See, for example, Liu et al., “Selecting an appropriate isotopic internal standard for gas chromatography/mass spectrometry analysis of drugs of abuse—pentobarbital example,” J. Forensic Sci.; November 1995; 40(6): 938-9.) The absolute amount of internal standard detected during a sample analysis can be predetermined by empirical testing of the particular internal standard incorporated into a particular substrate under specified ionization conditions. Typically, the amount of the internal standard is well above the limit of quantitation but not so high as to suppress the ionization of the analyte.

A variety of types of samples can be analyzed using the methods described herein, including biological, medical, industrial, agricultural, laboratory and food samples. For biological and medical applications, samples can include any biological fluid, cell, tissue, or fraction thereof, that includes molecules corresponding to the selected internal standards. A sample can be, for example, a specimen obtained from a subject (e.g., a mammal such as a human) or can be derived from such a subject. For example, a sample can be a tissue section obtained by biopsy, or cells that are placed in or adapted to tissue culture. Exemplary samples therefore include cultured fibroblasts, cultured amniotic fluid cells, and chorionic villus sample. A sample can also be a biological fluid specimen such as urine, blood, plasma, serum, saliva, semen, sputum, cerebral spinal fluid, tears, mucus, and the like. A sample can be further fractionated, if desired, to a fraction containing particular cell types. For example, a blood sample can be fractionated into serum or into fractions containing particular types of blood cells such as red blood cells or white blood cells (leukocytes). If desired, a sample can be a combination of samples from a subject such as a combination of a tissue and fluid sample, and the like. Methods for obtaining samples that preserve the activity or integrity of molecules in the sample are well known to those skilled in the art. Such methods include the use of appropriate buffers and/or inhibitors, including nuclease, protease and phosphatase inhibitors, which preserve or minimize changes in the molecules in the sample. Such inhibitors include, for example, chelators such as ethylenediamne tetraacetic acid (EDTA), ethylene glycol bis(Paminoethyl ether)N,N,N1,N1-tetraacetic acid (EGTA), protease inhibitors such as phenylmethylsulfonyl fluoride (PMSF), aprotinin, leupeptin, antipain and the like, and phosphatase inhibitors such as phosphate, sodium fluoride, vanadate and the like. Appropriate buffers and conditions for isolating molecules are well known to those skilled in the art and can be varied depending, for example, on the type of molecule in the sample to be characterized (see, for example, Ausubel et al. Current Protocols in Molecular Biology (Supplement 47), John Wiley & Sons, New York (1999); Harlow and Lane, Antibodies: A Laboratory Manual (Cold Spring Harbor Laboratory Press (1988); Harlow and Lane, Using Antibodies: A Laboratory Manual, Cold Spring Harbor Press (1999); Tietz Textbook of Clinical Chemistry, 3rd ed. Burtis and Ashwood, eds. W. B. Saunders, Philadelphia, (1999)).

The invention is well suited to newborn blood screening, which generally involves assaying more than twenty analytes in a sample. Tables 1 and 2 list analytes typically tested in a newborn blood assay. For many of the disorders diagnosable using newborn blood levels of these analytes, several criteria for diagnosis have been reported in the literature. For example, phenylketonuria may be indicated by the level of phenylalanine alone (as reported by CDC, U.S. Department of Health and Human Services, “Using Tandem Mass Spectrometry for Metabolic Disease Screening Among Newborns,” MMWR_Apr. 13, 2001; Vol. 50, No. RR-3; Rashed et al., Clinical Chemistry; 1997; 43(7):1129-41; and The Wisconsin NBS Laboratory—Wisconsin State Laboratory of Hygiene, “Health Professionals Guide to Newborn Screening,” retrieved Oct. 28, 2003, from the website of The Board of Reagents of the University of Wisconsin System). Alternatively, the level of tyrosine may be additionally considered (ACMG/ASHG Test and Technology Transfer Committee Working Group, Tandem Mass Spectrometry in Newborn Screening, Genetics in Medicine; July/August 2000; 2(4); and Schulze et al., Pediatrics; 2003; 111(6):1399-1406). A third approach considers the level of phenylanaline and the Phe/Tyr ratio (Zytkovicz et al., Clinical Chemistry; 2001; 47(11):1945-55).

Six criteria have been reported for diagnosing the fatty acid oxidation disorder known as medium-chain acyl-CoA dehydrogenase deficiency (MCAD), none of which relies on a single indicator. One paradigm uses levels of C8 and C10:1. (ACMG/ASHG Test and Technology Transfer Committee Working Group). A second additionally uses levels of C10 and C6 (CDC). A third considers the ratio C8/C10 in addition to the four individual levels (Chace et al., Clinical Chemistry; 2001; 47:1166-82). A fourth approach considers only levels of C6, C8, C10:1 (Rashed et al. and Zytkovicz et al.). A fifth approach considers individual levels of C6, C8, C10, and the ratios C8/C2, C8/C10 and C8/C12 (Schulze et al.) A sixth selects individual levels of C6, C8, and C10:1 and the ratio C8/C10 (Wisconsin NBS Laboratory). The substrate of the invention is able to incorporate internal standards for all of these several analytes.

TABLE 1
Amino acids assayed in newborn blood screening

| Amino Acid | Abbreviation |
|---|---|
| Alanine | Ala |
| Arginine | Arg |
| Citruline | Cit |
| Glycine | Gly |
| Leucine | Leu |
| Methionine | Met |
| Ornithine | Orn |
| 5-Oxoproline | 5-Oxo Pro |
| Phenylalanine | Phe |
| Tyrosine | Tyr |
| Valine | Val |
| Proline | Pro |

TABLE 2
Carnitines assayed in newborn blood screening

| Carnitine | Abbreviation |
|---|---|
| Free carnitine | C0 |
| Acetylcarnitine | C2 |
| Propionylcarnitine | C3 |
| Malonylcarnitine | C3DC |
| Butyrylcarnitine | C4 |
| 3-Hydroxy-butyrylcarnitine | C4OH |
| Isovalerylcarnitine | C5 |
| Tiglylcarnitine | C5:1 |
| Glutarylcarnitine | C5DC |
| 3-Hydroxy-isovalerylcarnitine | C5OH |
| Hexanoylcarnitine | C6 |
| Adipylcarnitine | C6DC |
| Octanoylcarnitine | C8 |
| Octenoylcarnitine | C8:1 |
| Decanoylcarnitine | C10 |
| Decenoylcarnitine | C10:1 |
| Decadienoylcarnitine | C10:2 |
| Dodecanoylcarnitine | C12 |
| Dodecenoylcarnitine | C12:1 |
| Tetradecanoylcarnitine (Myristoylcarnitine) | C14 |
| Tetradecenoylcarnitine | C14:1 |
| Tetradecadienoylcarnitine | C14:2 |
| 3-Hydroxy-tetradecanoylcarnitine | C14OH |
| Hexadecanoylcarnitine (palmitoylcarnitine) | C16 |
| Hexadecenoylcarnitine | C16:1 |
| 3-Hydroxy-hexadecanoylcarnitine | C16OH |
| 3-Hydroxy-hexadecenoylcarnitine | C16:1OH |
| Octadecanoylcarnitine (Stearoylcarnitine) | C18 |
| Octadecenoylcarnitine (Oleylcarnitine) | C18:1 |
| Octadecadienoylcarnitine (Linoleylcarnitine) | C18:2 |
| 3-Hydroxy-octadecanoylcarnitine | C18OH |
| 3-Hydroxy-octadecenoylcarnitine | C18:1OH |

It will therefore be seen that the foregoing represents a highly advantageous approach to quantitative surface-interrogation mass spectrometry, especially for quantitation of blood components. The terms and expressions employed herein are used as terms of description and not of limitation, and there is no intention, in the use of such terms and expressions, of excluding any equivalents of the features shown and described or portions thereof, but it is recognized that various modifications are possible within the scope of the invention claimed.

What is claimed is:

1. A method for determining a quantity of a first analyte in a sample by mass spectrometry, the method comprising the steps of:
a. providing a solid substrate having a surface and incorporating a known amount of a first internal standard corresponding to the first analyte;
b. disposing the sample on the surface;
c. transferring energy to the substrate so as to ionize the first analyte and the first internal standard, thereby generating first analyte ions and first internal standard ions;
d. collecting the first analyte ions and the first internal standard ions in a mass spectrometer so as to generate a first analyte signal from the first analyte ions and a first internal standard signal from the first internal standard ions;
e. calculating the quantity of the first analyte based on the first analyte signal, the first internal standard signal and the known amount of the first internal standard.

2. The method of claim 1 wherein the sample comprises blood.

3. The method of claim 1 wherein transferring energy to the substrate is accomplished by bombarding the surface with particles.

4. The method of claim 3 wherein the particles are transferred by spraying.

5. The method of claim 4 wherein the particles are charged.

6. The method of claim 3 wherein the particles are in electrically neutral excited states.

7. The method of claim 1 wherein transferring energy to the substrate is accomplished by firing a laser at the surface.

8. The method of clam 1 wherein the analyte is an amino acid.

9. The method of claim 1 wherein the analyte is a hormone.

10. The method of claim 1 wherein the analyte is a hemoglobin variant.

11. The method of claim 1 wherein the substrate incorporates a known amount of a second internal standard corresponding to a second analyte to be quantitated in the sample, the step of transferring energy to the substrate ionizes the second analyte and the second internal standard to generate second analyte ions and second internal standard ions, the step of collecting the ions also collects the second analyte ions and second internal standard ions in the mass spectrometer, and further comprising the step of calculating a quantity of the second analyte in the sample based on the second analyte signal and the second internal standard signal and the known amount of the second internal standard.

12. The method of claim 11 wherein the substrate further incorporates a known amount of each of a plurality of internal standards, each of which corresponds to one of a plurality of analytes to be quantitated in the sample, the step of transferring energy to the substrate ionizes each of the plurality of analytes and each of the plurality of internal standards to generate analyte ions from each of the plurality of analytes and internal standard ions from each of the plurality of internal standards, the step of collecting the ions also collects the plurality analyte ions and the plurality internal standard ions in the mass spectrometer so as to generate respective analyte signals and internal standard signals, and further comprising the step of calculating a quantity of each of the plurality of analytes based on the respective analyte signal, the respective internal standard signal and the known amount of the respective internal standard.

13. A method of screening blood by mass spectrometry for at least one disorder, a first analyte indicating a first disorder, a first internal standard corresponding to the first analyte, the method comprising the steps of:
a. providing a solid substrate having a surface and incorporating a known amount of the first internal standard;
b. disposing the blood on the surface;
c. transferring energy to the substrate so as to ionize the first analyte and the first internal standard, thereby generating first analyte ions and first internal standard ions;
d. collecting the first analyte and first internal standard ions in a mass spectrometer so as to generate a first analyte signal from the first analyte ions and a first internal standard signal from the first internal standard ions;
e. determining whether the first disorder is present by calculating the quantity of the first analyte in the blood based on the first analyte signal and the first internal standard signal and the known amount of the first internal standard.

14. The method of claim 13 wherein the substrate incorporates a known amount of a second internal standard corresponding to a second analyte indicating a second disorder, the step of transferring energy to the substrate ionizes the second analyte and the second internal standard to generate second analyte ions and second internal standard ions, the step of collecting the ions also collects the second analyte ions and second internal standard ions in the mass spectrometer so as to generate a second analyte signal form the second analyte ions and a second internal standard signal from the second internal standard ions, further comprising the step of determining whether the second disorder is present by calculating a quantity of the second analyte in the blood based on the second analyte signal and the second internal standard signal and the known amount of the second internal standard.

15. The method of claim 13 wherein the substrate further incorporates a known amount of each of a plurality of internal standards, each of which corresponds to one of a plurality of analytes each indicating one of a plurality of disorders, the step of transferring energy to the substrate ionizes each of the plurality of analytes and each of the plurality of internal standards to generate analyte ions from each of the plurality of analytes and internal standard ions from each of the plurality of internal standards, the step of collecting the ions also collects the plurality analyte ions and the plurality internal standard ions in the mass spectrometer so as to generate respective analyte signals and internal standard signals, and further comprising the step of determining whether each of the plurality of disorders is present by calculating a quantity of each of the plurality of analytes based on the respective analyte signal, the respective internal standard signal, and the known amount of the respective internal standard.

16. A solid substrate for receiving a sample to be assayed for a first analyte corresponding to a first internal standard and for bearing the sample during analysis by mass spectrometry, the substrate comprising:
a. a supporting material; and
b. a known amount of the first internal standard joined to the supporting material.

17. The substrate of claim 16 wherein the substrate is a paper card.

18. The substrate of claim 16 wherein the supporting material has a face, the first internal standard coating at least a portion of the face.

19. The substrate of claim 16 wherein the first internal standard impregnates the supporting material.

20. The substrate of claim 16 wherein the first internal standard is joined to the supporting material by dissolving the internal standard in a solvent to form a solution and immersing at least a portion of the supporting material in the solution.

21. The substrate of claim 16 wherein the first internal standard is joined to the supporting material by spraying the internal standard onto the supporting material.

22. The substrate of claim 16 wherein the substrate receives a liquid fluid that later dries on the substrate.

23. The substrate of claim 16 wherein the sample received by the substrate is blood.

24. The substrate of claim 17 wherein the sample received by the substrate is blood.

25. The substrate of claim 16 wherein a known amount of a second internal standard is joined to the supporting material, the second internal standard corresponding to a second analyte to be assayed in the sample.

26. The substrate of claim 16 wherein a known amount of each of a plurality of internal standard is further joined to the supporting material, each of the plurality of internal standards corresponding to one of the plurality of analytes to be assayed in the sample.

27. The substrate of claim 1 wherein the sample is a biological sample.

28. The substrate of claim 27 wherein the sample is selected from a bodily fluid or tissue or fraction thereof.
